(19) United States
(12) Patent Application Publication
(10) Pub. No.: US 2013/0335542 A1
(43) Pub. Date: Dec. 19, 2013

(54) ELECTRONIC DEVICE

(71) Applicants: FIH (Hong Kong) Limited, Kowloon (HK); Shenzhen Futaihong Precision Industry Co., Ltd., Shenzhen (CN)

(72) Inventor: JIAN-HUI LI, Shenzhen (CN)

(21) Appl. No.: 13/917,649

(22) Filed: Jun. 14, 2013

(30) Foreign Application Priority Data
Jun. 15, 2012 (CN) 201210197934X

(51) Int. Cl. G06K 19/06

(52) U.S. Cl. CPC G06K 19/06206
USPC 348/61; 235/492

(57) ABSTRACT

An electronic device includes a main body, a magnetic plate, an integrated circuit (IC) plate, and a display. The main body includes a first surface, a second surface opposite to the first surface, and a side surface connected substantially perpendicularly to the first and second surfaces. The second surface defines a first receiving groove. The side surface defines a second receiving groove communicating with the first receiving groove. The magnetic plate is slidably received in the first receiving groove. The IC plate is slidably received in the second receiving groove. The display screen is located on the first surface.

### BACKGROUND

1. Technical Field

The disclosure generally relates to electronic devices, and particularly to an electronic device having functions of different smart cards.

2. Description of the Related Art

People often carry a number of credit cards, integrated circuit (IC) cards, and membership cards in their wallets, which is inconvenient to carry and use. Furthermore, magnetic strips of different cards may interfere with each other and the cards may be demagnetized.

Therefore, there is room for improvement within the art.

### BRIEF DESCRIPTION OF THE DRAWINGS

Many aspects of an exemplary electronic device can be better understood with reference to the following drawings. The components in the drawings are not necessarily drawn to scale, the emphasis instead being placed upon clearly illustrating the principles of the exemplary electronic device. Moreover, in the drawings, like reference numerals designate corresponding parts throughout the several views. Wherever possible, the same reference numbers are used throughout the drawings to refer to the same or like elements of an embodiment.

FIG. 1 is a schematic view of an electronic device, according to a first embodiment.

FIG. 2 is an exploded view of the electronic device shown in FIG. 1.

FIG. 3 is similar with FIG. 2, but shown from another angle.

FIG. 4 is a schematic view of a main body shown in FIG. 1.

FIG. 5 is an enlarged view of a circular part V shown in FIG. 2.

FIG. 6 is an enlarged view of a circular part VI shown in FIG. 3.

FIG. 7 is a block diagram of the electronic device shown in FIG. 1.

FIG. 8 is a schematic view of the electronic device shown in FIG. 1, in a usage state.

FIG. 9 is a schematic view of an electronic device, according to a second embodiment.

### DETAILED DESCRIPTION

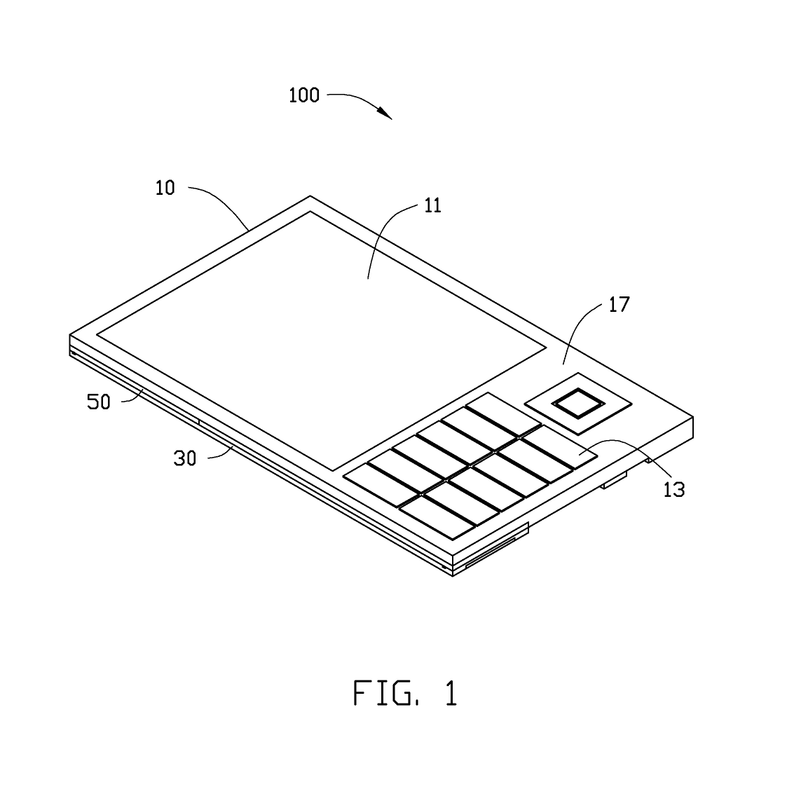

FIG. 1 shows an electronic device 100, according to a first embodiment. The electronic device 100 includes a main body 10, a magnetic plate 30 and an integrated circuit (IC) plate 50. The magnetic plate 30 and the IC plate 50 can slide in and out of the main body 10.

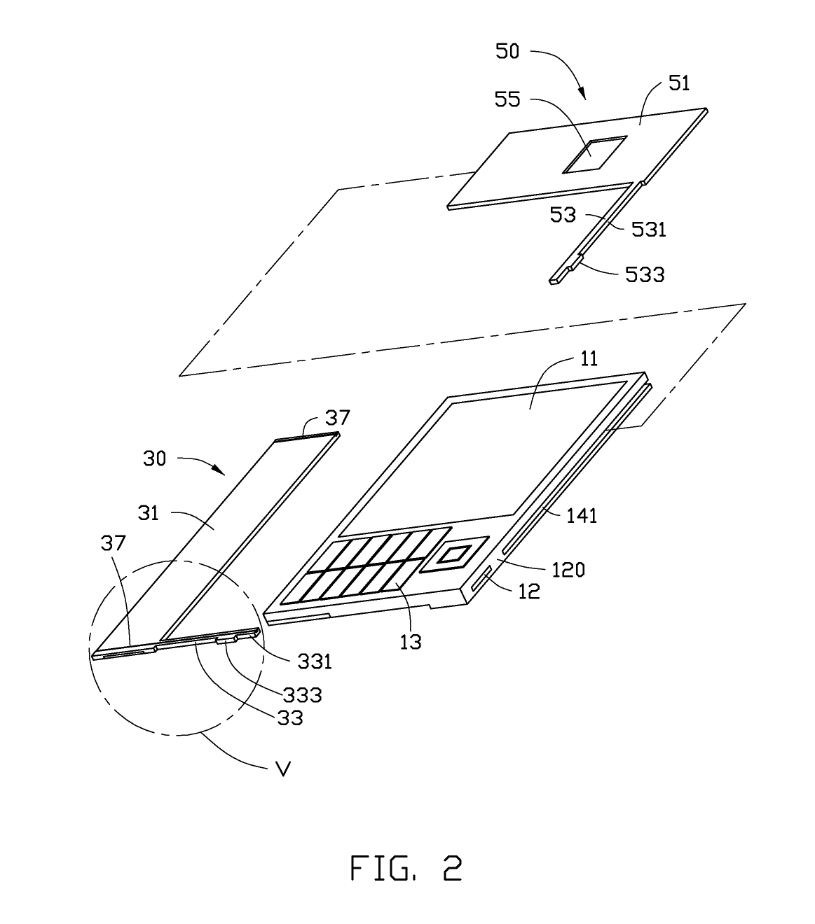

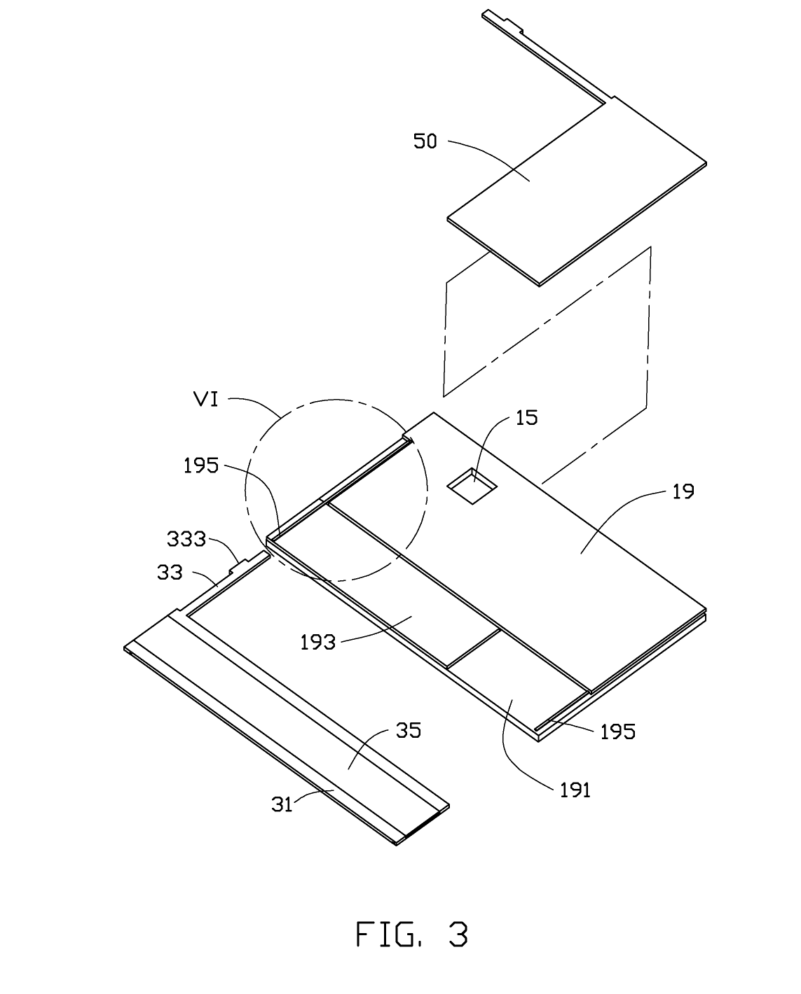

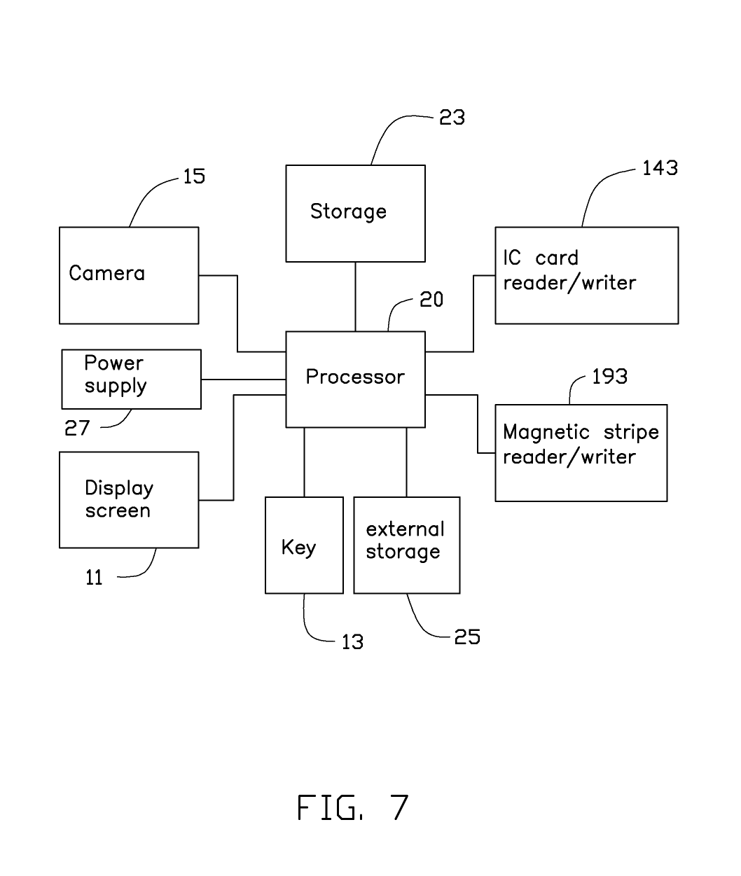

FIGS. 2 and 3 show that the main body 10 includes a display screen 11, a plurality of keys 13 and a camera 15. The display screen 11 and the plurality of keys 13 are located on a first surface 17 of the main body 10. The camera 15 is located on a second surface 19 of the main body 10 opposite to the first surface 17. A side surface 120 is substantially perpendicularly connected to the first surface 17 and the second surface 19. A slot 12 is defined in the side surface 120 for receiving a storage element (e.g., an external storage 25 shown in FIG. 7).

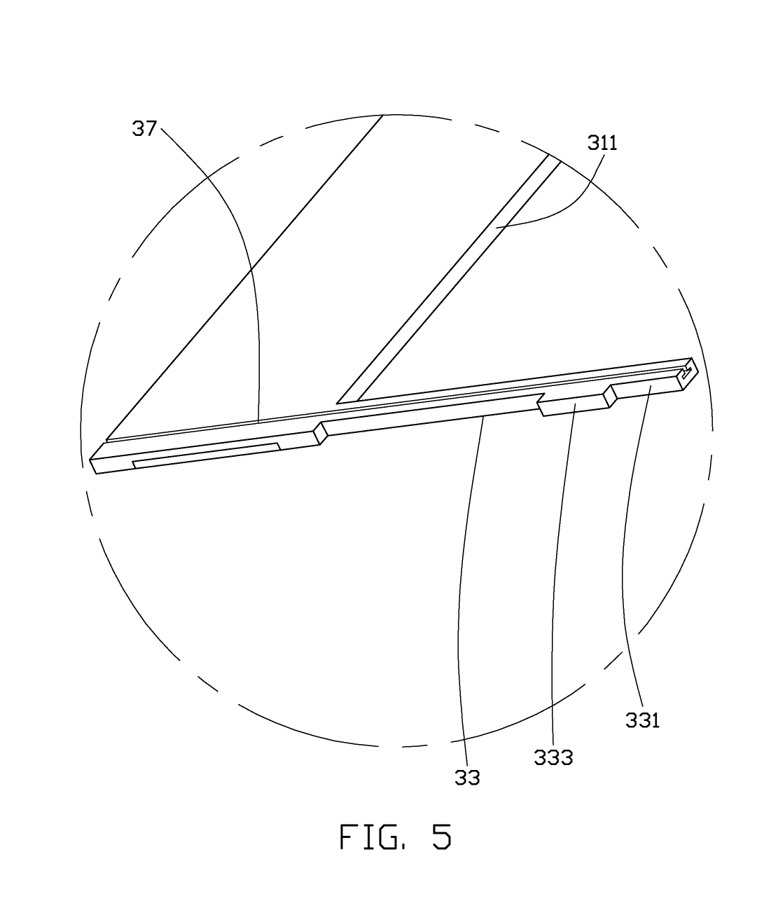

The magnetic plate 30 includes a base 31 and a sliding bar 33 extending substantially perpendicularly from an end of the base 31. A magnetic strip 35 is located on a middle area of the base 31. A protrusion 333 extends away from the base 31 from one edge 331 of the sliding bar 33. The protrusion 333 can be pushed to slide the magnetic plate 30 in and out of the main body 10. FIG. 5 shows that the base 31 defines two inverted T-shaped guiding slots 37 positioned at opposite ends of the base 31.

The IC plate 50 includes a plate body 51 and a rod 53. The rod 53 extends substantially perpendicularly from an end of the plate body 51. A chip 55 is located on the plate body 51. A projection 533 extends from an edge 531 of the rod 53. The projection 533 can be pushed to slide the IC plate 50 in and out of the main body 10.

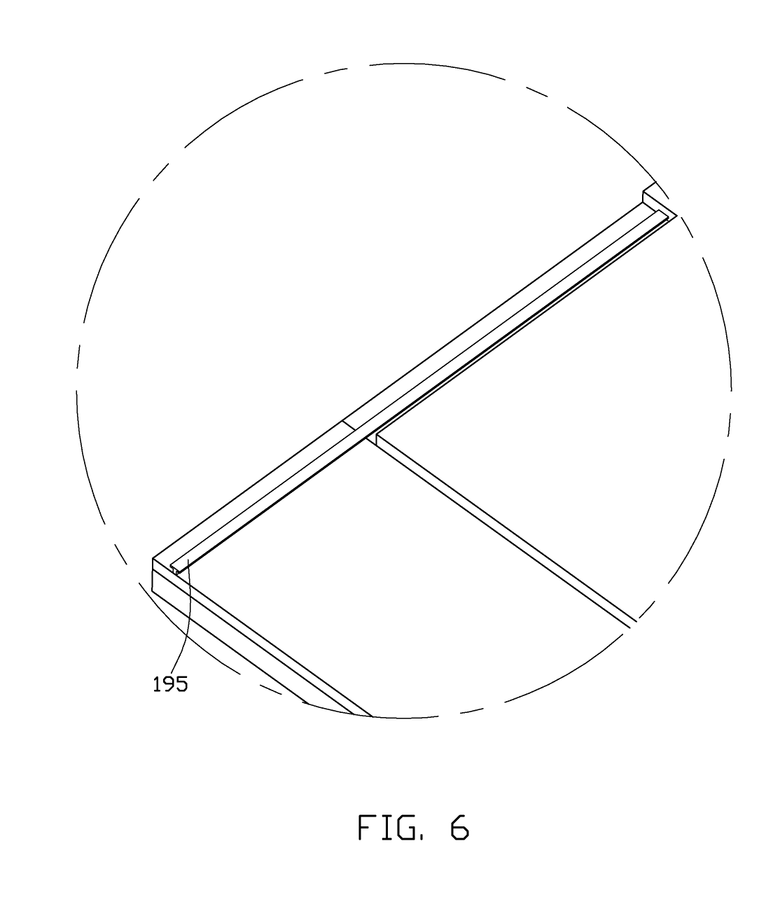

FIG. 3 shows that the second surface 19 defines a first receiving groove 191 for receiving the magnetic plate 30. A magnetic strip reader/writer 193 is located on a bottom wall of the first receiving groove 191. The magnetic strip reader/writer 193 is for writing magnetic information from a process unit (e.g., a processor 20 shown in FIG. 7) to the magnetic strip 35. FIG. 6 shows two substantially parallel T-shaped sliding rails 195 are located in the first receiving groove 191. Each sliding rail 195 is slidably received in the guiding slot 37.

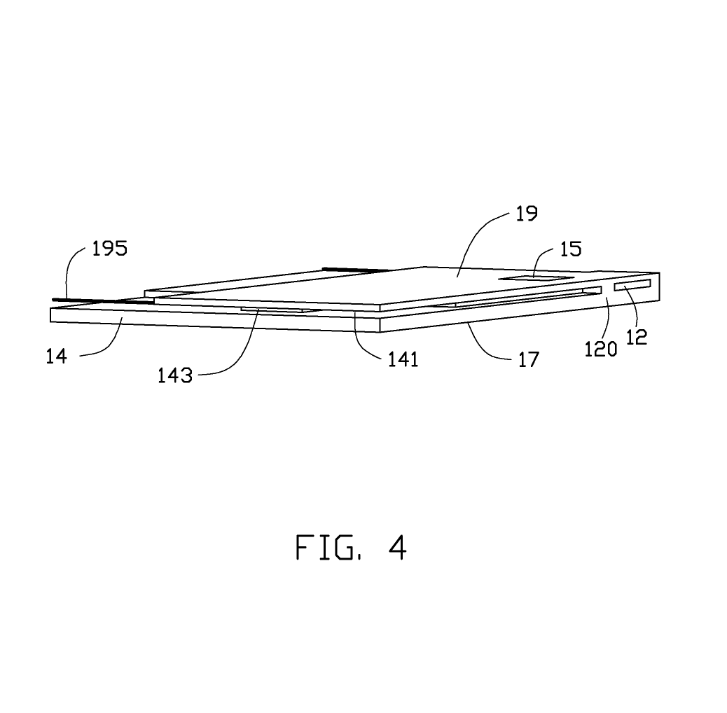

FIG. 4 shows that the main body 10 further includes an end wall 14 connected to the side surface 120. The end wall 14 connects the first surface 17 to the second surface 19. The side surface 120 defines a second receiving groove 141 communicating with the first receiving groove 191. The second receiving groove 141 runs through the end wall 14 for receiving the IC plate 50. An IC card reader/writer 143 is located on a bottom wall of the second receiving groove 141. The IC card reader/writer 143 is for writing chip information from a process unit (e.g., a processor 20 shown in FIG. 7) to the IC plate 50.

FIG. 7 shows that the electronic device 100 further includes a processor 20, a storage 23, and a power supply 27. Both the storage 23 and the power supply 27 are electronically connected to the processor 20. In this embodiment, the processor 20, the storage 23 and the power supply 27 are located on a printed circuit board (not shown) inside the main body 10. The display screen 11, the camera 15, the IC card reader/writer 143, and the magnetic strip reader/writer 193 are also connected to the processor 20. An external storage 25, such as a secure digital memory card, is received in the slot 12, and is further electronically connected to the processor 20. The external storage 25 is configured for storing both magnetic information and chip information from a number of credit cards, integrated circuit (IC) cards, and membership cards.

The assembly process of the electronic device 100 is as follows.

The IC plate 50 is inserted into the second receiving groove 141 and the chip 55 contacts the card reader/writer 143. Each guiding slot 37 of the magnetic plate 30 is aligned with a corresponding sliding rail 195, and then the magnetic plate 30 is pushed towards the main body 10 using the protrusion 333 until the T-shaped sliding rails 195 are slid into and received in the guiding slots 37.

The operation of the electronic device 100 is as follows.

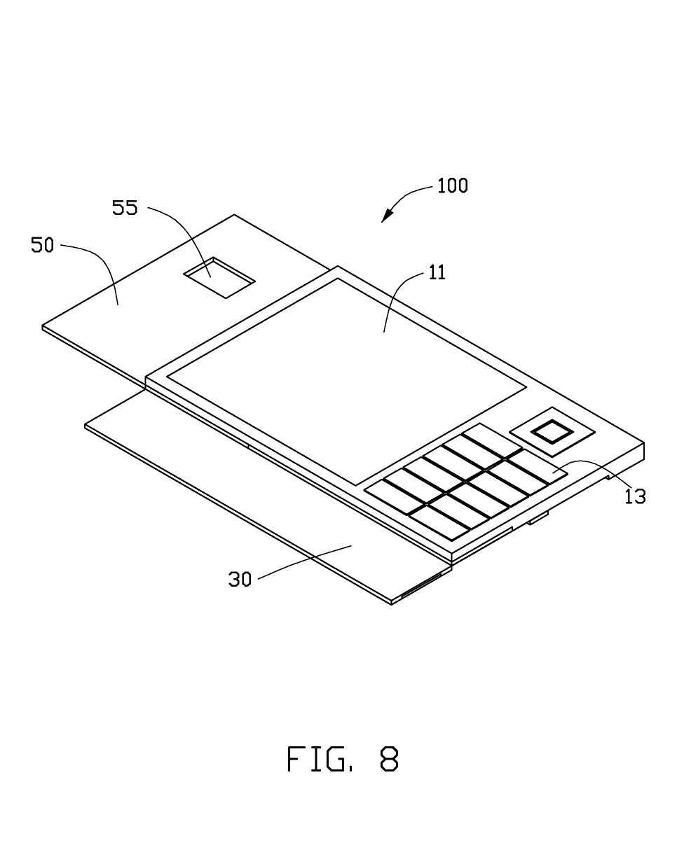

First, the external storage 25 is received in the slot 12. The processor 20 obtains magnetic strip information from the external storage 25 and writes the obtained magnetic strip information to the magnetic strip 35 through the magnetic strip reader/writer 193. Next, the processor 20 obtains chip information from the external storage 25 and writes the obtained chip information to the chip 55 through the IC card reader/writer 143. Also referring to FIG. 8, when the magnetic plate 30 needs to be used, the protrusion 333 is used to slide the magnetic plate 30 out along the sliding rail 195 until the base 31 is exposed outside the main body 10. Thus, the magnetic plate 30 can be operated. Similarly, when the IC plate 50 needs to be used, the projection 533 is used to slide out the plate body 51 of the IC plate 50 to be exposed outside the main body 10. Thus, the IC plate 50 can be operated.

Furthermore, the camera 15 can capture figure codes, such as two dimensional codes, bar codes from cards, and transmit the captured figure codes to the processor 20. The processor 20 controls the display screen 11 to display the captured figure codes for scanning and identifying.

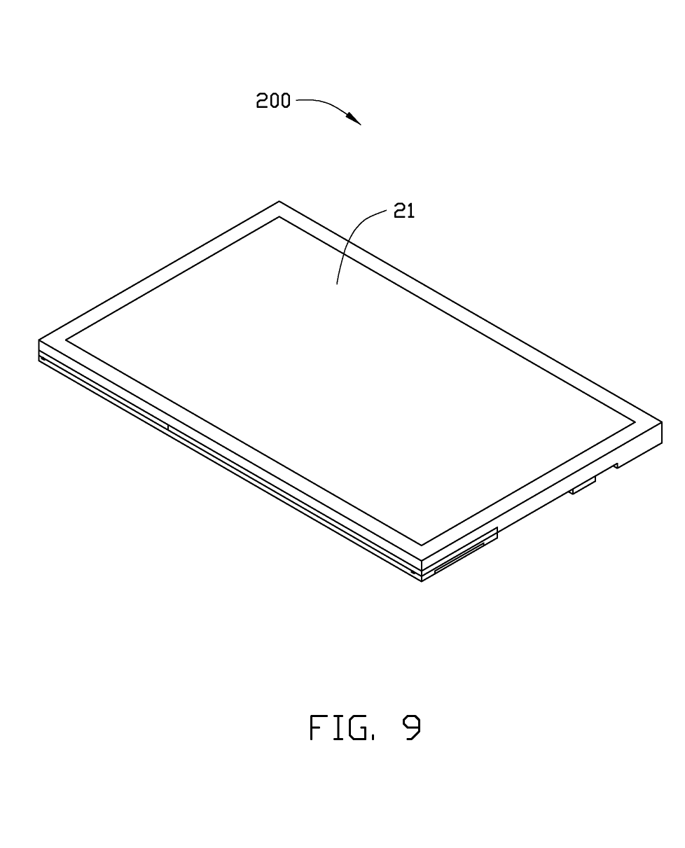

FIG. 9 shows an electronic device 200, according to a second embodiment. The electronic device 200 differs from the electronic device 100 only in that the display screen 21 is a touch panel, and thus the keys can be omitted.

The electronic device of the disclosure includes the IC plate and the magnetic plate, and can capture figure codes and display the captured figure codes. The electronic device has the functions of different smart cards and thus users do not need to carry many cards, which is convenient. Furthermore, the electronic device only includes a magnetic strip, which can effectively prevent the magnetic strip from being demagnetized.

It is to be understood, however, that even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. An electronic device, comprising:
a main body comprising a first surface, a second surface opposite to the first surface, and a side surface connected substantially perpendicularly to the first and second surfaces, the second surface defining a first receiving groove, the side surface defining a second receiving groove communicating with the first receiving groove;
a magnetic plate slidably received in the first receiving groove;
an integrated circuit (IC) plate slidably received in the second receiving groove; and
a display screen located on the first surface.

2. The electronic device of claim 1, wherein the magnetic plate comprises a base, a sliding bar extending from an end of the base, and a magnetic strip located on the base.

3. The electronic device of claim 2, wherein the magnetic plate further comprises a protrusion extending from one edge of the sliding bar for allowing the magnetic plate to slide in and out of the main body.

4. The electronic device of claim 2, wherein the IC plate comprises a plate body, a rod extending from an end of the plate body, and a chip located on the plate body.

5. The electronic device of claim 4, wherein the IC plate further comprises a projection extending from an end of the rod for allowing the IC plate to slide in and out of the main body.

6. The electronic device of claim 2, wherein the magnetic plate further comprises two guiding slots defined on a surface of the base opposite to the magnetic strip, the main body further comprises two substantially parallel sliding rails located in the first receiving groove, and each sliding rail is slidably received in a corresponding guiding slot.

7. The electronic device of claim 4, wherein the main body further comprises a magnetic strip reader/writer located in the first receiving groove corresponding to the magnetic strip and an IC reader/writer located in the second receiving groove corresponding to the chip.

8. The electronic device of claim 7, further comprising a camera located on the second surface.

9. The electronic device of claim 8, further comprising a processor, wherein the display screen, the camera, the IC reader/writer, and the magnetic strip reader/writer are all electronically connected to the processor.

10. An electronic device, comprising:
a main body comprising a first surface, a second surface opposite to the first surface, and a side surface connected substantially perpendicularly to the first and second surfaces, the second surface defining a first receiving groove, the side surface defining a second receiving groove communicating with the first receiving groove;
a magnetic plate slidably received in the first receiving groove;
an integrated circuit (IC) plate slidably received in the second receiving groove; and
a camera located on the second surface.

11. The electronic device of claim 10, wherein the magnetic plate comprises a base, a sliding bar extending from an end of the base, and a magnetic strip located on the base.

12. The electronic device of claim 11, wherein the magnetic plate further comprises a protrusion extends from one edge of the sliding bar for allowing the magnetic plate to slide in and out of the main body.

13. The electronic device of claim 11, wherein the IC plate comprises a plate body, a rod extending from an end of the plate body, and a chip located on the plate body.

14. The electronic device of claim 13, wherein the IC plate further comprises a projection extends from an end of the rod for allowing the IC plate to slide in and out of the main body.

15. The electronic device of claim 11, wherein the magnetic plate further comprises two guiding slots defined on a surface of the base opposite to the magnetic strip, the main body further comprises two substantially parallel sliding rails located in the first receiving groove, and each sliding rail is slidably received in a corresponding guiding slot.

16. The electronic device of claim 13, wherein the main body further comprises a magnetic strip reader/writer located in the first receiving groove corresponding to the magnetic strip and an IC reader/writer located in the second receiving groove corresponding to the chip.

17. The electronic device of claim 16, further comprising a processor, wherein the IC reader/writer and the magnetic strip reader/writer are both connected to the processor.

18. The electronic device of claim 17, further comprising a display, wherein the camera and the display are both connected to the processor, the camera captures figure codes of the electronic device and transmits the captured figure codes to the processor, and the processor controls the display screen to display the captured figure codes for scanning and identifying.
